(19) United States
(12) Patent Application Publication
(10) Pub. No.: US 2024/0198406 A1
(43) Pub. Date: Jun. 20, 2024

(54) METHOD AND DEVICE FOR SHEET METAL BENDING OR SHEET METAL CUTTING WITH REDUCED FORMATION OF FLAKES

(71) Applicants: thyssenkrupp Automotive Body Solutions GmbH, Heilbronn (DE); thyssenkrupp AG, Essen (DE)

(72) Inventors: Thorsten SCHUNK, Nonnweiler (DE); Gabriel HUCK, Wadern (DE)

(73) Assignees: thyssenkrupp Automotive Body Solutions GmbH, Heilbronn (DE); thyssenkrupp AG, Essen (DE)

(21) Appl. No.: 18/538,141

(22) Filed: Dec. 13, 2023

(30) Foreign Application Priority Data
Dec. 15, 2022 (DE) 10 2022 133 478.3

(51) Int. Cl. B21D 37/18; B21D 5/02; B21D 28/00

(52) U.S. Cl. CPC B21D 37/18; B21D 5/02; B21D 28/00

(57) ABSTRACT

A method for processing a sheet metal part using a sheet metal working tool of a sheet metal working device, wherein the sheet metal working tool is a cutting blade or a press-brake jaw, wherein a sheet metal part to be processed is fixed on a cutting attachment or on a press-brake attachment by a blank holder, and the sheet metal working tool for processing the sheet metal part, proceeding from an initial position (A), carries out a lowering movement in the direction of the fixed sheet metal part. The sheet metal working tool in the process is lowered in such a way that a sheet metal contact region of the sheet metal working tool impacts the sheet metal part, and the sheet metal part is cut to size or bent by means of the sheet metal working tool.

### CROSS REFERENCE TO RELATED APPLICATION

This application is a U.S. Non-Provisional that claims priority to German Patent Application No. DE 10 2022 133 478.3, filed Dec. 15, 2022, and the entire content of which is incorporated herein by reference.

### FIELD

The disclosure generally relates to a method for for processing a sheet metal part, in particular an aluminium-sheet part, using a sheet metal working tool of a sheet metal working device, wherein the sheet metal working tool is a cutting blade or a press-brake jaw.

### BACKGROUND

A sheet metal part to be processed is disposed on a cutting attachment, or on a press-brake attachment, respectively, and fixed on the attachment by a blank holder. Proceeding from an initial position, the sheet metal working tool for processing the sheet metal part carries out a lowering movement in the direction of the fixed sheet metal part, wherein the sheet metal working tool is lowered in such a way that a sheet metal contact region of the sheet metal working tool impacts the sheet metal part, and the sheet metal part is cut to size by means of the sheet metal working tool if the sheet metal working tool is a cutting blade, and the sheet metal part is bent by means of the sheet metal working tool if the sheet metal working tool is a press-brake jaw.

The disclosure furthermore relates to a sheet metal working device for processing a sheet metal part, in particular an aluminium-sheet part, comprising a sheet metal working tool, wherein the sheet metal working tool is a cutting blade or a press-brake jaw, furthermore comprising a cutting attachment or a press-brake attachment, respectively, and a blank holder for fixing a sheet metal part to be processed. The sheet metal working tool has a sheet metal contact region which, during the processing of the sheet metal part, impacts the sheet metal part to be processed. Moreover, for processing a sheet metal part, the sheet metal working tool is designed to be moved laterally along the blank holder and the attachment. Moreover, the disclosure relates to a method for retrofitting an existing conventional sheet metal working device.

Sheet metal working devices in the context of the present disclosure are, in particular, tools which are used in automotive presses in particular for processing sheet metal parts for vehicle bodies. Inner and outer skin parts for a vehicle body, for example for a vehicle door blank, are thus in particular cut by the sheet metal working devices.

Bending a sheet metal by means of a sheet metal working device, wherein a press-brake die, a blank holder and press-brake jaws are used during the bending of the sheet metal, is described in DE 10 2012 103 543 A1, for example. A method and a device for cutting sheet metal parts are disclosed in DE 10 2018 112 056 A1, for example.

In such processing of metals in the construction of bodies, in particular when processing aluminium, cold welds and consequently undesirable flakes occur when bending and cutting sheet metals. Cold welds in metalworking are created by interactions on the atomic level during direct contact between friction partners. Cold welds can be created in particular when cutting and when bending sheet metals, whereby a cutting blade, also referred to as the upper blade, or a press-brake jaw, respectively, contacts the sheet metal during processing. These cold welds not only lead to increased wear on tools, but are also the cause of the formation of flakes, thus small particles which are blown around during processing and may be disseminated in an uncontrolled manner. In this way, the flakes can cause surface issues on the final product, which require re-working of the processed sheet metal part, or lead to scrap. Moreover, the consequence may be downtime of the processing line, because the affected tools have to be cleaned.

Thus a need exists to improve a method and a sheet metal working device for processing a sheet metal part, advantageously with a view to better avoiding surface issues in sheet metal parts to be processed, and to minimizing wear on tools.

### BRIEF DESCRIPTION OF THE FIGURES

Further advantageous details, features and details of the disclosure will be explained in more detail in the context of the exemplary embodiments illustrated in the figures (Fig.: Figure), in which:

FIGS. 1a-d show in schematic lateral views an embodiment of a sheet metal working device according to the disclosure, configure for cutting a sheet metal part in a method according to the disclosure.

FIGS. 2a-d show in schematic lateral views an embodiment of a sheet metal working device according to the disclosure, configure for cutting a sheet metal part in a method according to the disclosure.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The solution proposed provides a method for processing a sheet metal part, in particular an aluminium-sheet part, using a sheet metal working tool of a sheet metal working device, wherein the sheet metal working tool is a cutting blade or a press-brake jaw. The sheet metal working device is provided in particular for the construction of bodies in the automotive industry, and is used in particular in conjunction with known presses which can in particular also be used for forming sheet metal. In the method, a sheet metal part to be processed is in particular first disposed on an attachment, wherein the attachment is a cutting attachment if the sheet metal working tool is a cutting blade, and the attachment is a press-brake attachment if the sheet metal working tool is a press-brake jaw, and the sheet metal part disposed on the attachment is fixed on the attachment by a blank holder of the sheet metal working device. The sheet metal working tool for processing the sheet metal part, proceeding from an initial position, then carries out a lowering movement in the direction of the fixed sheet metal part, wherein the sheet metal working tool is lowered in such a way that a sheet metal contact region of the sheet metal working tool impacts the sheet metal part, and the sheet metal part is cut to size by means of the sheet metal working tool if the sheet metal working tool is a cutting blade, and the sheet metal part is bent by means of the sheet metal working tool if the sheet metal working tool is a press-brake jaw. The sheet metal contact region is wetted with a fluid, in particular with an oil, furthermore particularly with a non-water-miscible, low-viscosity oil to which are added preferably synthetic solids and phosphoric EP additives. The wetting of the sheet metal contact region with the fluid is performed in particular before the sheet metal contact region impacts the sheet metal part. The sheet metal contact region is in particular wetted with the fluid during the lowering movement of the sheet metal working tool. For processing the sheet metal part, the sheet metal contact region wetted with the fluid then impacts the sheet metal part, wherein the fluid forms a separation layer between the sheet metal working tool and the sheet metal part. As a result of this separation layer, the creation of cold welds is advantageously counteracted, and a formation of flakes is thus prevented or at least reduced. As a result, the service life of the working tools is advantageously prolonged, on the one hand, this resulting in fewer cycles being needed in which cold welds have to be removed from the working tool. Furthermore advantageously, the amount of rework required on the sheet metal parts processed by the processing device is also reduced. Moreover, less scrap advantageously arises, and production losses are reduced. The term “fluid” is presently used in the chemical context as a liquid medium, and in particular does not mean gases or plasmas.

The lowering movement of the working tool is in particular performed continuously. According to one design variant, the lowering movement may also be performed with interruptions, in particular with an interruption for wetting the sheet metal contact region with the fluid. The lowering movement is in particular carried out in such a manner that sufficient wetting of the sheet metal contact region takes place, which enables the separation layer between the sheet metal working tool and the sheet metal part to be formed. It is furthermore provided in particular that the wetting is not performed during the entire lowering movement, but in particular only for part of the lowering movement, furthermore particularly only at the beginning of the lowering movement.

According to an advantageous refinement of the method, the sheet metal working tool after cutting to size if the sheet metal working tool is a cutting blade, or after bending the sheet metal part if the sheet metal working tool is a press-brake jaw, is moved to the initial position, wherein the sheet metal contact region is additionally wetted with the fluid while being moved to the initial position. In this way, a fluid film on the sheet metal contact region can advantageously be better maintained, which advantageously furthermore improves the suppression of cold welds being formed when the working tool acts on the sheet metal part, and thus advantageously allows surface issues in the processed sheet metal parts to arise even more infrequently, and further reduces wear on tools.

A further advantageous design embodiment of the method provides that the fluid is provided by a fluid allocation reservoir, in particular is provided by a fluid allocation reservoir disposed on the blank holder. The sheet metal contact region is advantageously wetted with the fluid from the fluid allocation reservoir in the process. According to one design variant it can be provided that the fluid from the fluid allocation reservoir is sprayed onto the sheet metal contact region, in particular by means of a plurality of spray heads which are disposed on the blank holder and in this design variant are included in the fluid allocation reservoir.

It is provided in particular that the fluid allocation reservoir is supplied with fluid from a fluid storage unit. In this design, the fluid allocation reservoir advantageously has only a comparatively minor quantity of fluid on hand, as a result of which the fluid allocation reservoir advantageously has a minor requirement in terms of installation space. Fluid consumed by the fluid allocation reservoir is advantageously replenished in sufficient quantities by the fluid storage unit. The fluid storage unit herein advantageously has a significantly larger fluid holding capacity than the fluid allocation reservoir. It can be provided in particular that the fluid storage unit has a holding capacity of more than one litre, in particular a holding capacity of more than three litres, and the fluid allocation reservoir has a significantly smaller holding capacity, in particular a holding capacity of at most a plurality of centiliters. An uninterrupted operation of the sheet metal working device over a long period of time is advantageously enabled by the holding capacity of the fluid storage unit. The holding capacity of the fluid allocation reservoir is in particular adapted to the size of the sheet metal contact region to be wetted, in particular in such a manner that sufficient wetting with fluid is ensured at all times.

Furthermore advantageously, the fluid allocation reservoir is supplied with fluid in a controlled manner. The fluid allocation reservoir here is advantageously supplied with fluid as a function of a fluid consumption. It is provided in particular when controlling the fluid supply of the fluid allocation reservoir that a utilization of the sheet metal working tool is taken into account, wherein one replenishment procedure of the fluid allocation reservoir is in particular assigned a number of processing procedures. The supply of the fluid allocation reservoir with fluid is in particular controlled by an actuator unit, in particular by way of a pump.

Therefore, a further advantageous design embodiment of the method provides that a pump supplies the fluid allocation reservoir with fluid so as to be synchronized with the movement of the working tool, in particular in that the pump pumps fluid from the fluid storage unit into the fluid allocation reservoir so as to be synchronized with the movement of the working tool in such a way that fluid for wetting the sheet metal contact region can at all times be provided by the fluid allocation reservoir, and preferably a quantity of fluid which has been applied to the sheet metal contact region by the fluid allocation reservoir is directly compensated for by the quantity of fluid stored in the fluid storage unit.

According to a particularly advantageous design variant it is provided that the fluid allocation reservoir is an elastic absorbent textile element, in particular a felt element, which is impregnated with the fluid. The elastic absorbent textile element impregnated with the fluid is in this case advantageously disposed on the blank holder so as to be preloaded in relation to the sheet metal working tool situated at the same height level. The sheet metal contact region is then advantageously wetted with the fluid in that the sheet metal contact region contacts the textile element during the movement, in particular the lowering movement, or the lowering movement and the movement back to the initial position. The textile element is advantageously compressed as a result of the contacting action, and fluid which advantageously wets the sheet metal contact region is dispensed in the process. This design embodiment of the fluid allocation reservoir as an elastic absorbent textile element impregnated with the fluid is advantageously particularly cost-effective and low-maintenance. Moreover, in this design embodiment, uniform and complete wetting of the sheet metal contact region is advantageously particularly well achieved, which advantageously furthermore helps in avoiding surface issues in the processed sheet metal parts and in minimizing wear on tools.

The sheet metal working device for processing a sheet metal part, in particular an aluminium-sheet part, furthermore proposed for achieving the object mentioned at the outset, includes a sheet metal working tool, wherein the sheet metal working tool is a cutting blade or a press-brake jaw; an attachment, wherein the attachment is a cutting attachment if the sheet metal working tool is a cutting blade, and the attachment is a press-brake attachment if the sheet metal working tool is a press-brake jaw; and a blank holder, wherein the blank holder is designed to fix a sheet metal part, which is disposed on the attachment, for the processing of the sheet metal part. The sheet metal working tool of the sheet metal working device has a sheet metal contact region which for processing the sheet metal part impacts the sheet metal part to be processed, and for processing the sheet metal is designed to be moved laterally along the blank holder and the attachment. Furthermore, the sheet metal working device has a fluid allocation reservoir which is disposed on the blank holder and provides a fluid, in particular an oil, and is designed to wet the sheet metal contact region with a fluid, in particular to wet the sheet metal contact region with a fluid during the movement of the sheet metal working tool. As a result of this sheet metal working device, the occurrence of cold welds and thus of flake formation is advantageously heavily reduced, as a result of which the sheet metal working tools advantageously require less maintenance complexity and the number of processed sheet metal parts which require rework is reduced. It is provided in particular that the sheet metal working device is designed for use in an automotive press in the production of body components.

According to an advantageous design embodiment of the sheet metal working device, the fluid allocation reservoir is an elastic absorbent textile element, in particular a felt element, impregnated with the fluid. Using such a textile element, uniform and complete wetting of the sheet metal contact region can advantageously be achieved, in particular in such a manner that the fluid can form a separation layer between the sheet metal working tool and the sheet metal part to be processed. In this way, cold welds can advantageously be even further avoided. It is provided in particular that the elastic absorbent textile element which is impregnated with the fluid is disposed on the blank holder so as to be preloaded in relation to the sheet metal working tool situated at the same height level. As a result, the sheet metal working tool, which is moved past the textile element, advantageously presses against the textile element which is compressed as a result and advantageously dispenses a defined quantity of fluid to the sheet metal contact region. The preload force of the textile element in relation to the sheet metal working tool is advantageously adjustable and is advantageously adjusted in such a way that the sheet metal contact region is wetted with a quantity of fluid sufficient for forming the separation layer between the sheet metal working tool and the sheet metal part.

An advantageous refinement provides that the blank holder of the sheet metal working device has a groove. The fluid allocation reservoir, in particular the elastic absorbent textile element which is impregnated with the fluid, here is advantageously disposed in the groove. The groove here is advantageously designed so as to be substantially complementary to the sheet metal contact region and to this extent advantageously follows the 3D contour of the sheet metal contact region of the sheet metal working tool. Depending on the geometry of the component, corners and jumps are advantageously equipped with shaped inserts, in particular so as to further improve the formation of the separation layer, in particular in the case of special component geometries. It can additionally or alternatively be provided in particular that the textile element in terms of the shape is adapted to the 3D contour of the sheet metal contact region of the sheet metal working tool.

According to a further particularly advantageous design embodiment, the fluid is an oil, in particular a non-water-miscible low-viscosity oil to which are advantageously added synthetic solids and phosphoric EP additives. Such an oil has proven particularly successful as a fluid. It is provided in particular that the oil has a density between 800 kg/m³ (kg: kilogram; m: metre) and 860 kg/m³ according to DIN EN ISO 12185, furthermore particularly a density of 830 kg/m³. The viscosity of the oil at 40° C. (C: Celsius) is advantageously between 3.8 mm²/s (mm: millimeter; s: second) and 4.4 mm²/s according to ASTM D 7042, furthermore particularly 4.1 mm²/s.

Furthermore advantageously, the sheet metal working device includes a fluid storage unit in which a quantity of fluid is advantageously on hand. The fluid allocation reservoir is advantageously supplied with fluid by way of the fluid storage unit. The fluid storage unit advantageously has a significantly enlarged holding capacity in comparison to the fluid allocation reservoir, in particular as has already been stated above. Moreover, the sheet metal working device advantageously includes a pump, wherein the pump is advantageously designed to pump fluid from the fluid storage unit into the fluid allocation reservoir, or to the fluid allocation reservoir, respectively. The supply of fluid to the fluid allocation reservoir preferably takes place by way of bores in the groove base of the groove incorporated in the blank holder. These bores advantageously have a spacing between 90 mm and 210 mm, in particular a spacing between 120 mm and 180 mm, furthermore particularly a spacing of 150 mm. if the fluid allocation reservoir is a textile element, in particular a felt, designed to be elastic and absorbent, the fluid in this instance is advantageously distributed in the textile element by the capillary effect. Particularly positive results in terms of a sufficient supply of the fluid allocation reservoir with fluid have been achieved at a spacing of the bores of 150 mm, when the fluid allocation reservoir is a felt element and the fluid is an oil.

A further advantageous design embodiment provides that the sheet metal working device includes a control unit. The control unit is advantageously designed to control the pump of the sheet metal working device, in particular to control as a function of an activation of the sheet metal working tool. It can advantageously be achieved in this way that sufficient fluid is on hand in the fluid allocation reservoir and can be provided by the latter at all times. With a view to a simple design of the control unit it is provided in particular that the control unit, according to an installation of the sheet metal working device in a press, is manually switched on and the pump is controlled in such a manner that time-dependent cyclic pumping takes place, whereby fluid, in particular oil, is advantageously pumped from the fluid storage unit into the bores in the groove base, said coil then being received by the fluid allocation reservoir. According to an advantageous design variant of the control unit, the control unit is designed to transmit control signals to the pump, wherein at least one parameter, preferably a plurality of parameters, which relate(s) to the fluid requirement is/are advantageously evaluated by the control unit. The control unit is in particular designed to take into account at least one of the parameters mentioned hereunder, in particular a plurality of the parameters mentioned hereunder, for activating the pump and thus the delivery of the fluid quantity: number of strokes of the sheet metal working tool of the sheet metal working device; movement speed of the sheet metal working tool of the sheet metal working device; degree of wetting of the sheet metal contact region. The quantity of fluid which is able to be supplied to the fluid allocation reservoir, and thus in particular also the quantity of fluid that is able to be provided by the fluid allocation reservoir, is in particular adjustable, preferably synchronized by means of the pump.

It is furthermore provided in particular that the sheet metal working device is designed to carry out a method designed according to the disclosure, in particular once a sheet metal part to be processed has been disposed on the attachment. In particular, the sheet metal working device is designed to fix on the attachment a sheet metal part, which is disposed on the attachment, by the blank holder. Furthermore, the sheet metal working tool of the sheet metal working device, for processing the sheet metal part, is designed to carry out a lowering movement, proceeding from an initial position, in the direction of the fixed sheet metal part. The fluid allocation reservoir, in particular the textile element designed to be elastic and absorbent, here is designed to wet the sheet metal contact region with a fluid during the lowering movement of the sheet metal working tool. The sheet metal working tool is furthermore designed to be lowered in such a manner that the sheet metal contact region of the sheet metal working tool impacts the sheet metal part, wherein the fluid forms a separation layer between the sheet metal working tool and the sheet metal part, and wherein the sheet metal working tool, designed as a cutting blade, is furthermore designed to cut to size the sheet metal part, and the sheet metal working tool, designed as a press-brake jaw, is furthermore designed to bend the sheet metal part.

Finally, the present disclosure also provides that a conventional sheet metal working device is converted to a sheet metal working device designed according to the disclosure by means of a retrofitting method. The method proposed to this end provides that a conventional sheet metal working device is equipped with a flake formation reduction unit, wherein the flake formation reduction unit includes a fluid allocation reservoir and a fluid, preferably additionally a fluid storage unit and advantageously a pump for conveying the fluid from the fluid storage unit to the fluid allocation reservoir. Proposed in particular is a method for retrofitting a sheet metal working device with a flake formation reduction unit, wherein the sheet metal working device includes a sheet metal working tool, an attachment and a blank holder, wherein the sheet metal working tool has a sheet metal contact region which when processing the sheet metal part impacts the sheet metal part to be processed, wherein the sheet metal working tool for processing the sheet metal is designed to be moved laterally along the blank holder and the attachment, wherein the sheet metal working tool is a cutting blade or a press-brake jaw, wherein the attachment is a cutting attachment if the sheet metal working tool is a cutting blade, and the attachment is a press-brake attachment if the sheet metal working tool is a press-brake jaw, and wherein the blank holder is designed to fix a sheet metal part, which is disposed on the attachment, for the processing of the sheet metal part. The flake formation reduction unit includes at least one fluid allocation reservoir and a fluid, in particular an oil, wherein the fluid allocation reservoir is disposed on the blank holder, and the fluid allocation reservoir is enriched with the fluid, wherein the disposal of the fluid allocation reservoir is performed in such a manner that the sheet metal contact region of the sheet metal working tool is wetted with the fluid at least when carrying out a downwards movement towards a sheet metal part to be processed.

A sheet metal working device designed according to the disclosure can advantageously be provided in a comparatively cost-effective manner by means of the retrofit.

Identical parts are generally provided with the same reference signs in the various figures and are therefore sometimes also explained only in connection with one of the figures.

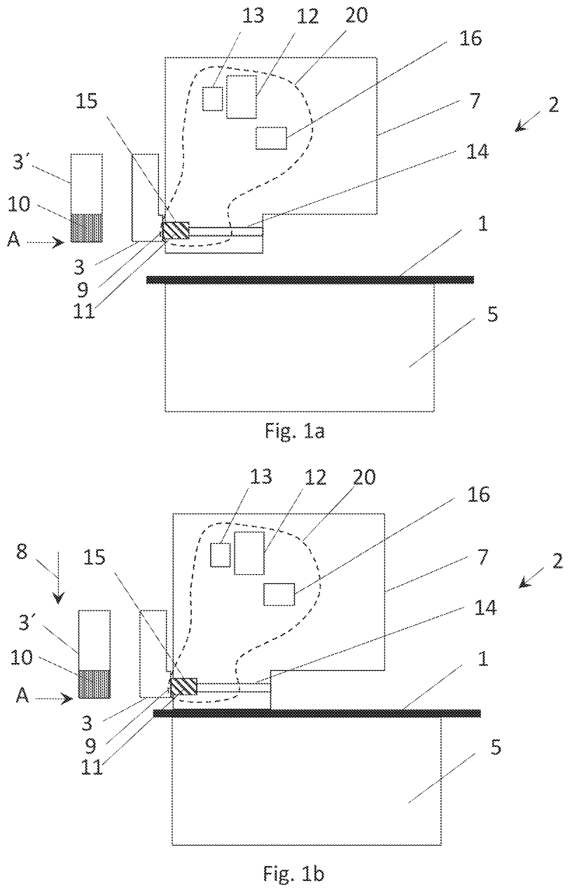

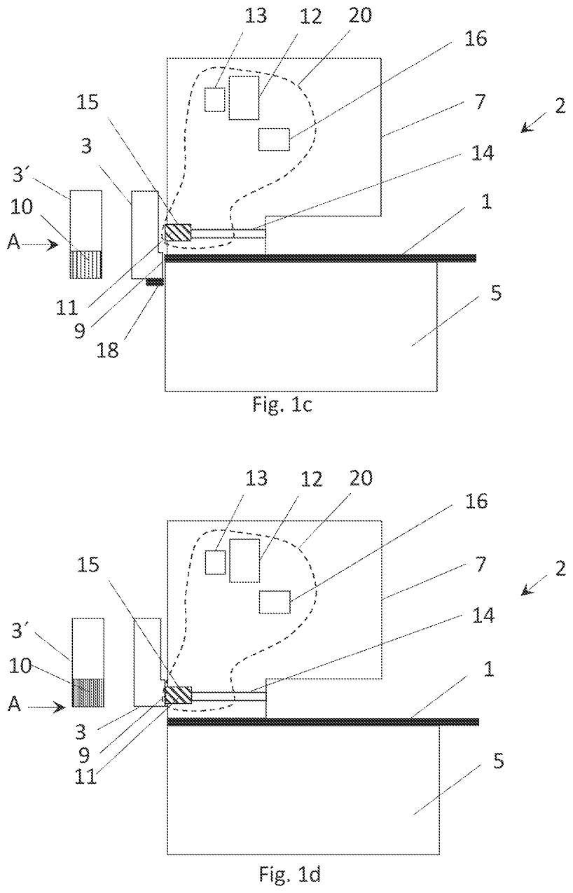

Illustrated in FIGS. 1a to 1d is in each case an exemplary embodiment of a sheet metal working device 2 when carrying out a method for cutting a sheet metal part 1, in this exemplary embodiment an aluminium-sheet blank, at different points in time. The sheet metal working device 2 in the exemplary embodiment illustrated in FIGS. 1a to 1d includes a sheet metal working tool which is designed as a cutting blade 3. The sheet metal working device 2 furthermore includes a cutting attachment 5 on which the sheet metal part 1 is disposed. The sheet metal working device 2 moreover has a blank holder 7 which is adjustable in height and to which the sheet metal part 1 can be fixed. The cutting blade 3 of the sheet metal working device 2 for cutting the sheet metal part 1 can be moved laterally along the blank holder 7 and the cutting attachment 5, and includes a sheet metal contact region 9 by way of which the cutting blade 3 acts on the sheet metal part 1 and contacts the sheet metal part 1 in the process.

The blank holder 7 of the sheet metal working device 2 has a groove 15 which is designed so as to be complementary to the sheet metal contact region 9 of the cutting blade 3 in such a way that the cutting blade 3 can be guided by the groove 15 when moving along the blank holder 7. A felt element, which can in particular include a plurality of felt pieces, is disposed here as a fluid allocation reservoir 11 in the groove 15. The felt element 11 here is supplied with oil 10 by a fluid storage unit 12 which is disposed on the blank holder 7 and filled with the oil 10, and by way of a pump 13 which is likewise disposed on the blank holder 7. The oil here is conveyed by means of the pump 13, by way of bores 14 in the groove base of the groove 15, to the felt element 11, wherein the felt element 11 by virtue of its absorbency can receive and provide a specific quantity of oil 10.

The felt element 11 is disposed in the groove 15 so as to be preloaded in relation to the cutting blade 3. This is implemented in such a way that part of the felt element 11 protrudes into the path which has to be passed through by the cutting blade 3 in the movement of the latter. In this arrangement, the felt element 11 is placed in such a way that in a movement of the cutting blade along the blank holder 7, the cutting blade 3 by way of its sheet metal contact region 9 contacts the felt element 11 and in the process, by virtue of the preloading, the felt element 11 is somewhat compressed by the cutting blade 3, as a result of which the felt element 11 dispenses part of the received oil 10 and in this way wets the sheet metal contact region 9 with the oil 10. As a result of the oil 10 applied to the sheet metal contact region 9, there is a separation layer between the sheet metal contact region 9 and the sheet metal part 1 to be cut when the cutting tool 3 by way of the sheet metal contact region 9 impacts the sheet metal part 1 and a part 18 of the sheet metal is cut off Flake formation is heavily reduced thanks to this separation layer. In FIG. 1a to FIG. 1d, the cutting blade 3 is additionally illustrated as the cutting blade 3′ in a frontal view rotated by 90°, in which the wetting of the sheet metal contact region 9 with the fluid 10 is schematically illustrated by lines, wherein the higher line density symbolizes heavy wetting with the fluid 10, and the lower line density symbolizes lighter wetting with the fluid 10.

In order for the sheet metal contact region 9 to always be wetted with a sufficient quantity of oil 10, a control unit 16 controls how much oil 10 is conveyed from the oil storage unit 12, which can be designed in particular as a canister or bottle, to the felt element 11 by means of the pump 13. A design embodiment for the control of the fluid supply here can provide that a small quantity of oil 10 is also conveyed from the fluid storage unit 12 to the felt element 11 each time the cutting tool 9 is moved back to the initial position. Should monitoring, which may take place in particular by sensors, indicate that too much oil 10 is conveyed to the felt element 11 in this way, the number of cycles at which a pumping procedure takes place is advantageously reduced in such a way that oil 10 is conveyed to the felt element 11 in particular only at every n^{th} movement of the cutting blade 3 back to the initial position A, where n is a natural number, in particular a number between 1 and 10.

In the exemplary embodiment shown in FIGS. 1a to 1d, FIG. 1a shows the sheet metal working device 2 at a point in time at which the cutting blade 3 is situated in the initial position A, from where a cutting procedure of a sheet metal part 1 commences. There is space here between the blank holder 7 and the cutting attachment 5 so as to dispose the sheet metal part 1 on the cutting attachment 7, wherein the sheet metal part 1 in FIG. 1a is illustrated as already being disposed on the cutting attachment 5.

FIG. 1b shows the sheet metal working device 2 at a point in time at which the blank holder 7 has carried out a stroke movement in the direction of the cutting attachment 5, as a result of which the sheet metal part 1 is fixed between the cutting attachment 5 and the blank holder 7.

Proceeding from this position, the cutting blade 3 commences the downwards movement 8 laterally along the blank holder 7 and the cutting attachment 5 in the direction of the sheet metal part 1. At the beginning of this downwards movement 8, the sheet metal contact region 9 is guided along the felt element 11, which is impregnated with oil 10, wherein the felt element 11 wets the sheet metal contact region 9 with oil 10 due to the pressure exerted on the felt element 11 in the process. Oil 10 is no longer dispensed once the sheet metal contact region 9 has passed the felt element 11, wherein the cutting blade 3 is lowered to the position illustrated in FIG. 1c, in which a part 18 of the sheet metal part 1 has already been cut off. Since the cutting operation has already taken place in the position illustrated in FIG. 1c, the quantity of oil on the sheet metal contact region 9 is now reduced. When the cutting blade 3 is subsequently moved back to the initial position A, which is illustrated in FIG. 1d, the sheet metal contact region 9 again passes the felt element 11, as a result of which the latter is also wetted with oil 10 during the upwards movement back to the initial position A. A uniform application of a sufficient quantity of oil is achieved as a result.

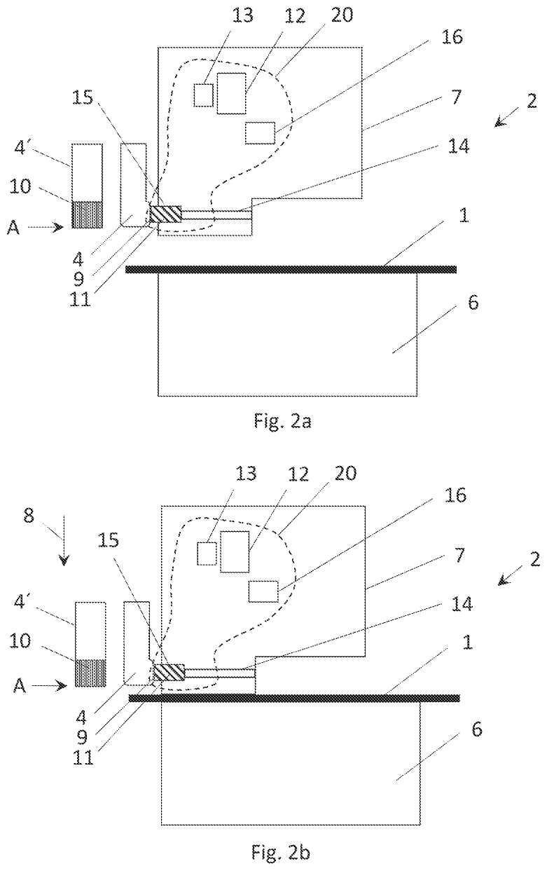

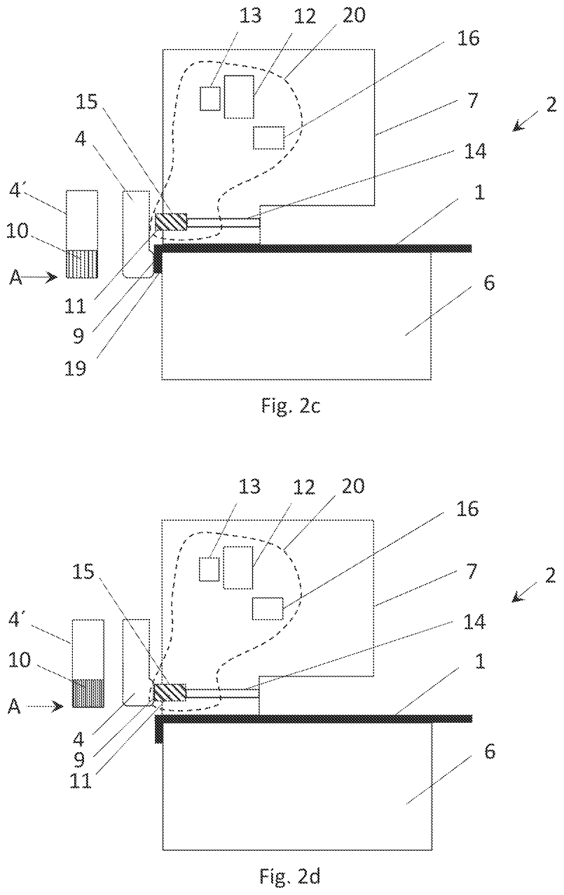

Illustrated in FIGS. 2a to 2d is in each case an exemplary embodiment of a sheet metal working device 2 when carrying out a method for bending a sheet metal part 1, in this exemplary embodiment an aluminium-sheet blank, at different points in time. The sheet metal working tool in this exemplary embodiment is designed as a press-brake jaw 4, which in FIGS. 2a to 2d is likewise additionally illustrated as a press-brake jaw 4′ in a frontal view rotated by 90°. Accordingly, the attachment in this exemplary embodiment is designed as a press-brake attachment 6. Herein lies the substantial difference between this exemplary embodiment and the sheet metal working device 2 according to the exemplary embodiment shown in FIGS. 1a to 1d. Otherwise, the sheet metal working device 2 is of a substantially identical construction. The groove 15, and the textile element incorporated as the fluid allocation reservoir 11 in the groove 15, here are adapted to the geometry of the sheet metal contact region 9 of the press-brake jaw 4. Likewise, the quantity of conveyed oil, which is conveyed from the fluid storage unit 12 to the fluid allocation reservoir 11, is adapted to the changed face of the sheet metal contact region 9 of the press-brake jaw 4.

Otherwise, FIG. 2a also shows the press-brake device 2 in the position in which the blank holder 7 and the press-brake attachment 6 are mutually spaced apart in such a way that the sheet metal blank 1 can be disposed on the press-brake attachment 6, as is shown in FIG. 2a. After the sheet metal blank] has been disposed, the blank holder 7 is lowered and thus fixes the sheet metal blank 1 on the press-brake attachment 6, as is shown in FIG. 2b. Thereafter, in a downwards movement 8 in the direction of the sheet metal blank 1, the press-brake jaw 4 is moved laterally along the blank holder 7 and the press-jaw attachment 6. At the beginning of this downwards movement 8, the sheet metal contact region 9 of the press-brake jaw 4 is guided past the textile element 11, which is impregnated with oil 10, such that oil 10 from the textile element 11 is applied to the sheet metal contact region 9 in the process, and the press-brake jaw 4 by way of the sheet metal contact region 9, which is covered with an oil film, impacts the sheet metal blank 1, which protrudes beyond the press-brake attachment 6, the oil film thus acting as a separation layer between the sheet metal contact region 9 and the sheet metal blank 1 contacted by the press-brake jaw 4 during bending of the sheet metal blank 1, a formation of flakes also being reduced here in this way. FIG. 2c shows the sheet metal blank 1 which has already been bent, having the bent sheet metal portion 19, wherein the press-brake jaw 4 is still illustrated in the terminal position of the stroke movement directed downwards Since the bending operation has been carried out at this point in time, the quantity of oil on the sheet metal contact region 9 of the press-brake jaw 4 is correspondingly reduced. The sheet metal contact region 9 of the press-brake jaw 4 is again wetted with oil 10 by the textile element 11 in the upwards-directed stroke movement back to the initial position A of the press-brake jaw 4, as is illustrated in FIG. 2d, such that the quantity of oil applied to the sheet metal contact region 9 is increased again.

The fluid allocation reservoir 11, in the exemplary embodiments discussed above thus the felt element or the textile element; the fluid storage unit 12; the pump 13; a supply line between the fluid storage unit 12 and the fluid allocation reservoir 11, which in the exemplary embodiments discussed above is implemented by the bores 14 but may in particular also be provided by hoses; and the control unit 16 conjointly form a flake formation reduction unit 20. A conventional sheet metal working device, for instance a cutting press, can advantageously also be designed to be a cutting press with a reduced formation of flakes by such a flake formation reduction unit 20. To this end, the flake formation reduction unit 20 is to be disposed on the sheet metal working device so as to be adapted to the geometry of the sheet metal contact region 9 of the sheet metal working tool, and the fluid storage unit 12 is to be filled with fluid, in particular with oil.

The exemplary embodiments illustrated in the figures and explained in the context thereof serve the purpose of explaining the disclosure and do not limit the latter.

### LIST OF REFERENCE SIGNS

1 Sheet metal part
2 Sheet metal working device
3 Cutting blade
3′ Cutting blade (frontal view)
4 Press-brake jaw
4′ Press-brake jaw (frontal view)
Cutting attachment
6 Press-brake attachment
7 Blank holder
8 Lowering movement
9 Sheet metal contact region
10 Fluid
11 Fluid allocation reservoir
12 Fluid storage unit
13 Pump
14 Bore
15 Groove
16 Control unit
18 Cut-off part of the sheet metal part (1)
19 Bent part of the sheet metal part (1)
20 Flake formation reduction unit
A Initial position

What is claimed is:

1. A method for processing a sheet metal part using a sheet metal working tool of a sheet metal working device, wherein the sheet metal working tool is a cutting blade or a press-brake jaw, wherein a sheet metal part to be processed is fixed on an attachment having a blank holder of the sheet metal working device, the attachment being a cutting attachment if the sheet metal working tool is a cutting blade, and the attachment being a press-brake attachment if the sheet metal working tool is a press-brake jaw, comprising:
lowering the sheet metal working tool for processing the sheet metal part, proceeding from an initial position (A), in the direction of the fixed sheet metal part; the sheet metal working tool, wherein a sheet metal contact region of the sheet metal working tool impacts the sheet metal part;
cutting to size by means of the sheet metal working tool the sheet metal part if the sheet metal working tool is a cutting blade, or bending the sheet metal part by means of the sheet metal working tool if the sheet metal working tool is a press-brake jaw;
wetting the sheet metal contact region with a fluid;
impacting the sheet metal part in the sheet metal contact region wetted with the fluid; and
forming a separation layer by the fluid between the sheet metal working tool and the sheet metal part.

2. The method of claim 1, wherein after cutting to size, or after bending the sheet metal part, the sheet metal working tool is moved to the initial position (A), wherein the sheet metal contact region is wetted with the fluid while being moved to the initial position (A).

3. The method of claim 1, wherein the fluid is provided by a fluid allocation reservoir disposed on the blank holder, and the sheet metal contact region is wetted with the fluid from the fluid allocation reservoir.

4. The method of claim 1, wherein the fluid allocation reservoir is supplied with fluid from a fluid storage unit.

5. The method of claim 1, wherein the fluid allocation reservoir is supplied with fluid in a controlled manner, and wherein a utilization of the sheet metal working tool is taken into account when controlling the fluid supply.

6. The method of claim 1, wherein a pump supplies the fluid allocation reservoir with fluid synchronized with a movement of the working tool.

7. The method of claim 1, wherein the fluid allocation reservoir is an elastic absorbent textile element which is impregnated with the fluid and is disposed on the blank holder so as to be preloaded in relation to the sheet metal working tool situated at the same height level, and wherein the sheet metal contact region is wetted with the fluid in that the sheet metal contact region contacts the textile element during the movement.

8. A sheet metal working device for processing a sheet metal part, comprising:
a sheet metal working tool, wherein the sheet metal working tool is a cutting blade or a press-brake jaw;
an attachment, wherein the attachment is a cutting attachment if the sheet metal working tool is a cutting blade, and the attachment is a press-brake attachment if the sheet metal working tool is a press-brake jaw; and
a blank holder, wherein the blank holder is configured to fix a sheet metal part disposed on the attachment for the processing of the sheet metal part, wherein the sheet metal working tool includes a sheet metal contact region which for processing a sheet metal part impacts the sheet metal part to be processed, and wherein the sheet metal working tool for processing the sheet metal part is configured to be moved laterally along the blank holder and the attachment, wherein a fluid allocation reservoir is disposed on the blank holder and provides a fluid and is configured to wet the sheet metal contact region with the fluid.

9. The sheet metal working device of claim 8, wherein the fluid allocation reservoir is an elastic absorbent textile element and is impregnated with the fluid and is disposed on the blank holder so as to be preloaded in relation to the sheet metal working tool situated at the same height level.

10. The sheet metal working device of claim 8, wherein the blank holder includes a groove, wherein the fluid allocation reservoir is disposed in the groove, and the groove is configured to be complementary to the sheet metal contact region.

11. The sheet metal working device of claim 8, wherein the fluid is a non-water-miscible, low-viscosity oil including synthetic solids and phosphoric EP additives.

12. The sheet metal working device of claim 8, further comprising a fluid storage unit and a pump, wherein the pump is configured to pump fluid from the fluid storage unit into the fluid allocation reservoir.

13. The sheet metal working device of claim 8, further comprising a control unit, wherein the control unit is designed to control the pump as a function of the activation of the sheet metal working tool.

14. The sheet metal working device of claim 8, wherein the sheet metal working device is configured to carry out a method according to claim 1.

15. A method for retrofitting an existing sheet metal working device comprising:
adding to the existing sheet metal working device a sheet metal working device including a flake formation reduction unit, a sheet metal working tool, an attachment, and a blank holder, wherein the sheet metal working tool includes a sheet metal contact region, for processing the sheet metal part, which impacts the sheet metal part to be processed, wherein the sheet metal working tool for processing the sheet metal is configured to be moved laterally along the blank holder and the attachment, wherein the sheet metal working tool is a cutting blade or a press-brake jaw, and the attachment is a cutting attachment if the sheet metal working tool is a cutting blade, and the attachment is a press-brake attachment if the sheet metal working tool is a press-brake jaw, and wherein the blank holder is configured to fix a sheet metal part, which is disposed on the attachment, for the processing of the sheet metal part, wherein the flake formation reduction unit includes a fluid allocation reservoir and a fluid, wherein the fluid allocation reservoir is disposed on the blank holder, and the fluid allocation reservoir is enriched with the fluid, wherein the disposal of the fluid allocation reservoir is performed in such a manner that the sheet metal contact region of the sheet metal working tool is wetted with the fluid at least when carrying out a downwards movement towards a sheet metal part to be processed.
